(19) United States
(12) Patent Application Publication
(10) Pub. No.: US 2026/0221706 A1
(43) Pub. Date: Jul. 30, 2026

(54) ELECTRICAL OUTLET

(71) Applicant: IT CREATION, INC., MIAMI BEACH, FL (US)

(72) Inventor: PIETRO MALANCA, PARMA (PR) (IT)

(21) Appl. No.: 19/037,246

(22) Filed: Jan. 26, 2025

(51) Int. Cl. H01R 29/00; H01R 13/453; H01R 13/74; H01R 25/00

(52) U.S. Cl. CPC H01R 29/00; H01R 13/4532; H01R 13/4534; H01R 25/006; H01R 13/748

(57) ABSTRACT

Electric power supply port comprising: i) a first electrical outlet (1) comprising: —first electrical contacts in turn comprising a first phase (11) and a first neutral (12); —a first group of holes in turn comprising at least a first and a second hole (13, 14), one associated with the first phase (11) and one associated with the first neutral (12) and intended to allow an insertion of corresponding pins of an external electric plug; ii) a second electrical outlet (2) side by side with the first electrical outlet (1); the second electrical outlet (2) comprising: —second electrical contacts in turn comprising a second phase (21) and a second neutral (22); —a second group of holes in turn comprising at least a third and a fourth hole (23, 24), one associated with the second phase (21) and one associated with the second neutral (22) and intended to allow an insertion of the corresponding pins of the external electric plug; the first, second, third and fourth hole (13, 14, 23, 24) are aligned according to this order along the same straight line; a distance between a geometric centre of gravity of the first hole (13) and a geometric centre of gravity of the second hole (14) being the same as a distance between a geometric centre of gravity of the second hole (14) and a geometric centre of gravity of the third hole (23) and being the same as a distance between a geometric centre of gravity of the third hole (23) and a geometric centre of gravity of the fourth hole (24); between one of the holes of the first group associated with the first phase (11) and one of the holes of the second group associated with the second phase (21), there being one of the holes of the first group associated with the first neutral (12) or one of the holes of the second group associated with the second neutral (22).

### FIELD OF THE INVENTION

The present invention relates to an electric power supply port.

### BACKGROUND OF THE INVENTION

Solutions are known comprising two recessed boxes side by side. A first box houses a first pair of electrical outlets placed one on top of the other.

A second box houses a second pair of electrical outlets placed one on top of the other.

Between the first pair of electrical outlets and the second pair of electrical outlets there is typically a dividing strip which connects in a single body with a frame surrounding the assembly of the first and the second pair of electrical outlets.

The user can therefore connect four electrical outlets at the same time; one at the top right, one at the bottom right, one at the top left and one at the bottom left. Each of the four electrical outlets is provided with a mechanical safety shutter to prevent a child from being electrocuted by inserting a finger into one of the holes of the outlet. The correct insertion of the two plug pins allows moving such a mechanical shutter, allowing the electric power supply.

Sometimes furnishing elements or other obstacles can make it more difficult to reach one or more of the electrical outlets to connect a plug therein. Therefore, the user will choose among the remaining ones. Furthermore, the user must pay attention to connecting the plug to one of the four available outlets, which can be hindered, for example, by the darkness in the room.

### BRIEF SUMMARY OF THE INVENTION

The task of the present invention is to provide an electric power supply port which allows limiting dimensions and at the same time ensures maximum flexibility of use.

Further characteristics and advantages of the present invention will become more apparent from the indicative and thus non-limiting description of an embodiment of an electric power supply port.

### BRIEF DESCRIPTION OF THE DRAWINGS

Such a description will be set out below with reference to the accompanying drawings, which are provided solely for illustrative and therefore non-limiting purposes, in which:

FIG. 1 shows a perspective view of an electric power supply port according to the present invention;

FIG. 2 shows the solution of FIG. 1 with some parts removed to better highlight others;

FIG. 3 shows the solution of FIG. 2 to which four electric plugs are connected;

FIG. 4 shows the solution of FIG. 2 to which an electric plug is connected;

FIG. 5 shows the solution illustrated in FIGS. 1-4 with some parts removed to better highlight others;

FIG. 6 shows a detail of FIG. 5;

FIG. 7 shows the solution of FIG. 6 from a different perspective and with some parts removed to better highlight others;

FIG. 8 shows a sectional view of FIG. 6 and with an electric plug connected;

FIG. 9 shows the solution of FIG. 8 without the electric plug connected;

FIG. 10 shows a further sectional view of the solution of FIG. 6;

FIG. 11 shows a particular configuration assumed by the solution of FIG. 6;

FIG. 12 shows an exploded view of a component of a power supply port according to the present invention;

FIGS. 13 and 14 show the rocker system, first and second shutter in two different operating conditions;

FIG. 15 shows a sectional view of the operating condition of FIG. 13;

FIG. 16 shows a sectional view of an operating condition in which several plugs are connected, different from that of FIG. 15;

FIG. 17 shows an electrical connection of the neutral and phase electrical contacts of the port of FIG. 1;

FIG. 18 shows an electrical connection of the grounding of the port of FIG. 1;

FIGS. 19 and 20 show a front and rear view of a solution of a port according to the present invention.

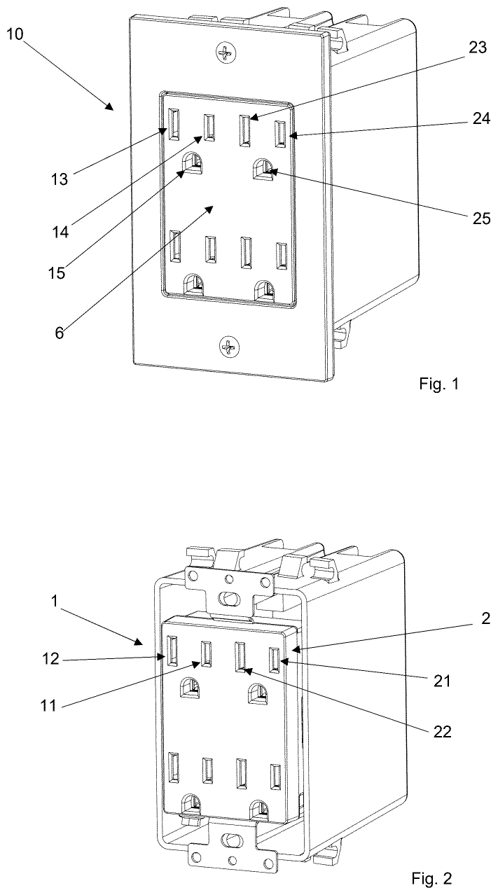

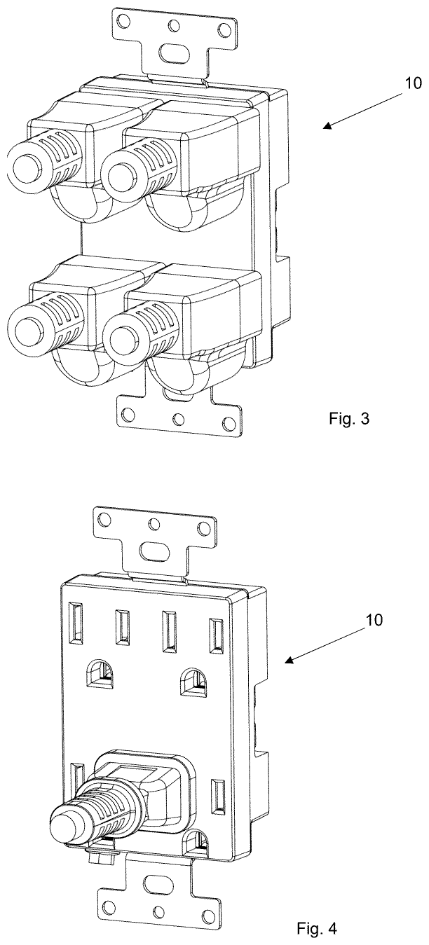

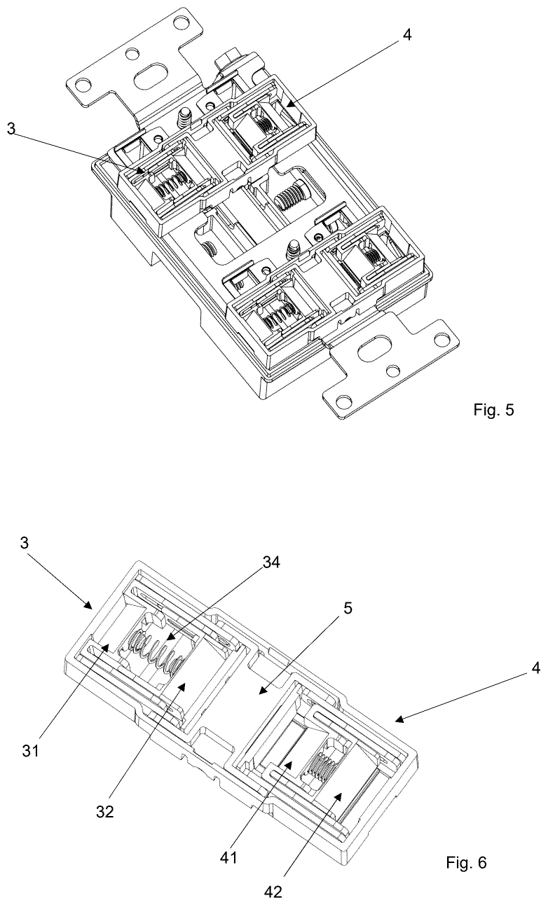

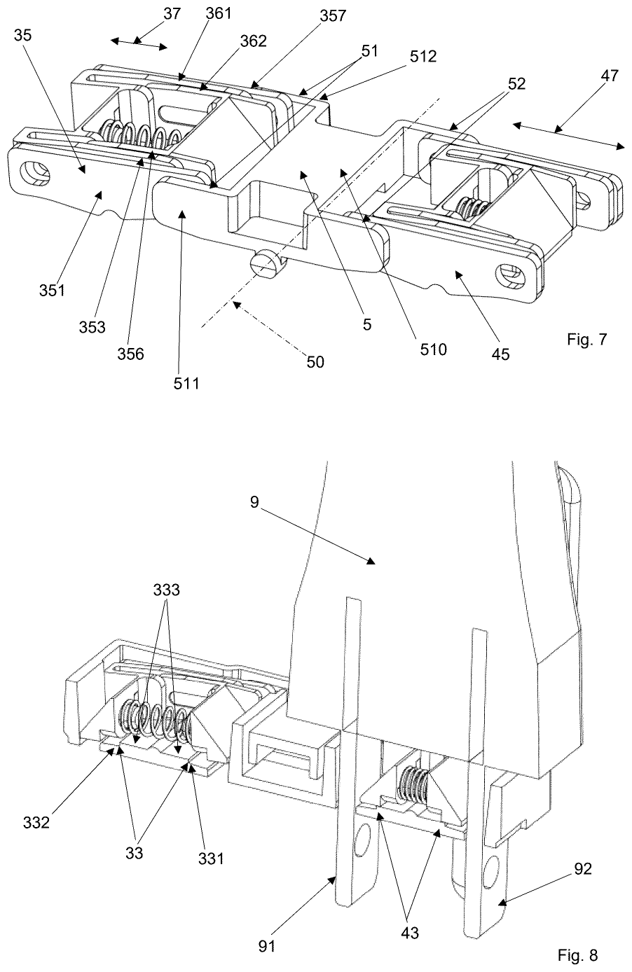

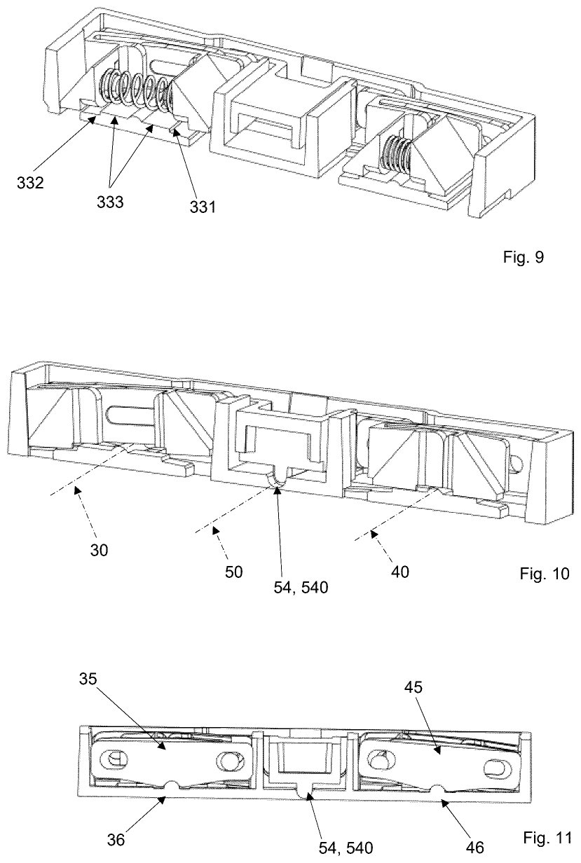

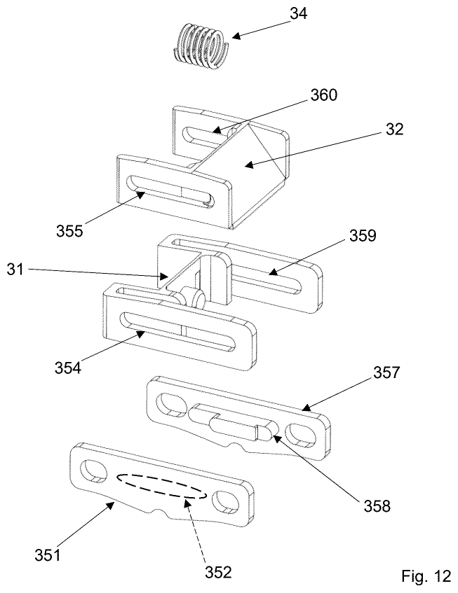

### DESCRIPTION OF EXAMPLE EMBODIMENTS

In the appended drawings, reference number 10 denotes an electric power supply port. Typically, but not necessarily, it is used in buildings or places intended to accommodate people. The port 10 comprises a first electrical outlet 1. The first electrical outlet 1 comprises first electrical contacts in turn comprising a first phase 11 and a first neutral 12. There can also possibly be an electrical contact 90 for grounding.

The first outlet 1 comprises a first group of holes in turn comprising at least a first and a second hole 13, 14, one associated with the first phase 11 and one associated with the first neutral 12 and intended to allow an insertion of corresponding pins of an external electric plug. The first outlet 1 allows the connection of a first plug. The electrical contact for grounding is typically associated with a further hole 15, not necessarily aligned with the first and the second hole 13, 14. Such a hole 15 is intended to house a cylindrical pin. The first and the second hole 13, 14 are typically intended to house parallelepiped pins.

The port 10 comprises a second electrical outlet 2 side by side with the first electrical outlet 1. Typically, the first and the second outlet 1, 2 are horizontally side by side. The same solution could possibly be rotated by 90°. The second electrical outlet 2 comprises second electrical contacts in turn comprising a second phase 21 and a second neutral 22. There can also possibly be an electrical contact for grounding. Typically, the first outlet 1 is of the American type. One or more of the characteristics described with reference to the first outlet 1 can be repeated for the second outlet 2.

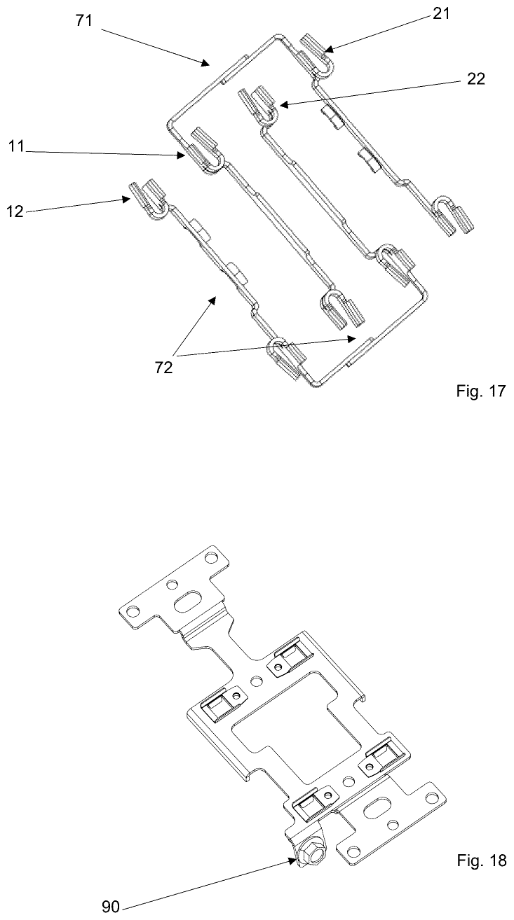

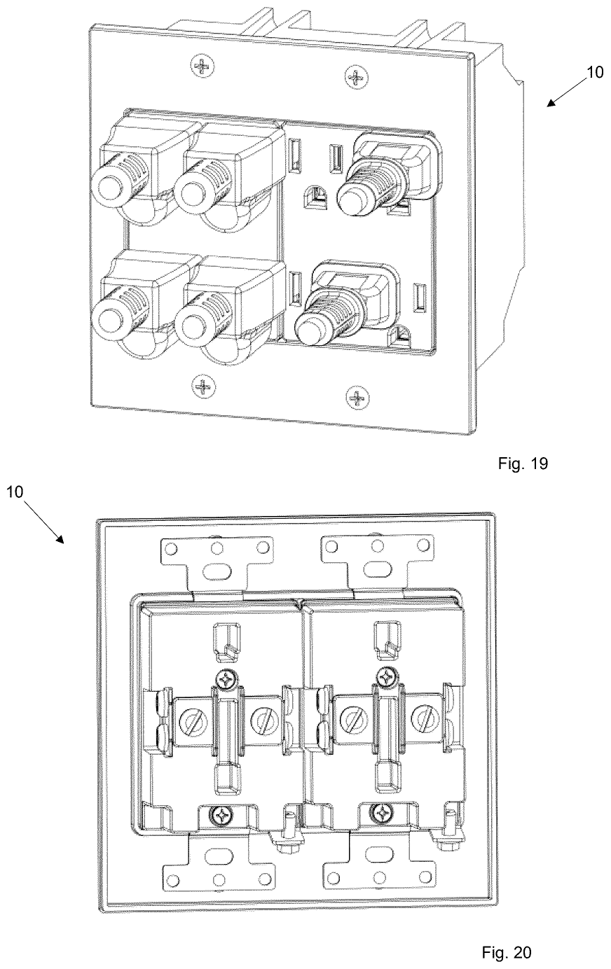

The second outlet 2 comprises a second group of holes in turn comprising at least a third and a fourth hole 23, 24, one associated with the second phase 21 and one associated with the second neutral 22 and intended to allow an insertion of the corresponding pins of an external electric plug. The second outlet 2 allows the connection of a second plug (or the first plug); the first and the second plug can be identical). The first phase 11 and the second phase 21 are electrically connected and are in electrical contact with the phase of a power supply line of the port 10. The first neutral 12 and the second neutral 22 are electrically connected and are in electrical contact with the neutral of a power supply line of the port 10. For example, FIG. 17 shows a first connection section 71 of the first phase 11 and of the second phase 21. It also shows a second connection section 72 of the first neutral 12 and of the second neutral 22.

The third and the fourth hole 23, 24 have been named in such a way so as to distinguish them from the first and second hole 13, 14 of the first outlet 1. This does not necessarily mean that the second outlet 2 also has other holes. However, the second outlet 2 possibly also comprises a further hole 25 for grounding.

The first, second, third and fourth hole 13, 14, 23, 24 are aligned according to this order along the same straight line (there could possibly be other holes present therebetween). Typically, the straight line is horizontal. A distance between a geometric centre of gravity of an inlet mouth of the first hole 13 and a geometric centre of gravity of an inlet mouth of the second hole 14 is the same as a distance between the geometric centre of gravity of the inlet mouth of the second hole 14 and a geometric centre of gravity of an inlet mouth of the third hole 23. Similarly, it is the same as a distance between the geometric centre of gravity of the inlet mouth of the third hole 23 and a geometric centre of gravity of an inlet mouth of the fourth hole 24. Between one of the holes of the first group associated with the first phase 11 and one of the holes of the second group associated with the second phase 21, there is one of the holes of the first group associated with the first neutral 12 or one of the holes of the second group associated with the second neutral 22.

That is, a hole connected to the phase alternates with a hole connected to the neutral. In particular, the first, second, third, fourth hole 13, 14, 23, 24 are associated with the first neutral 12, the first phase 11, the second neutral 22 and the second phase 21, respectively.

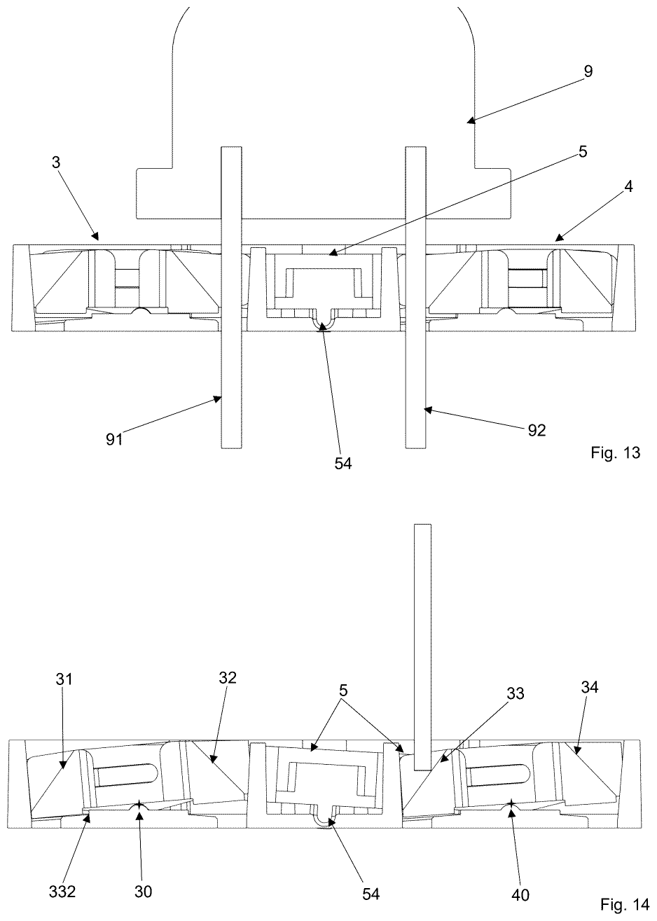

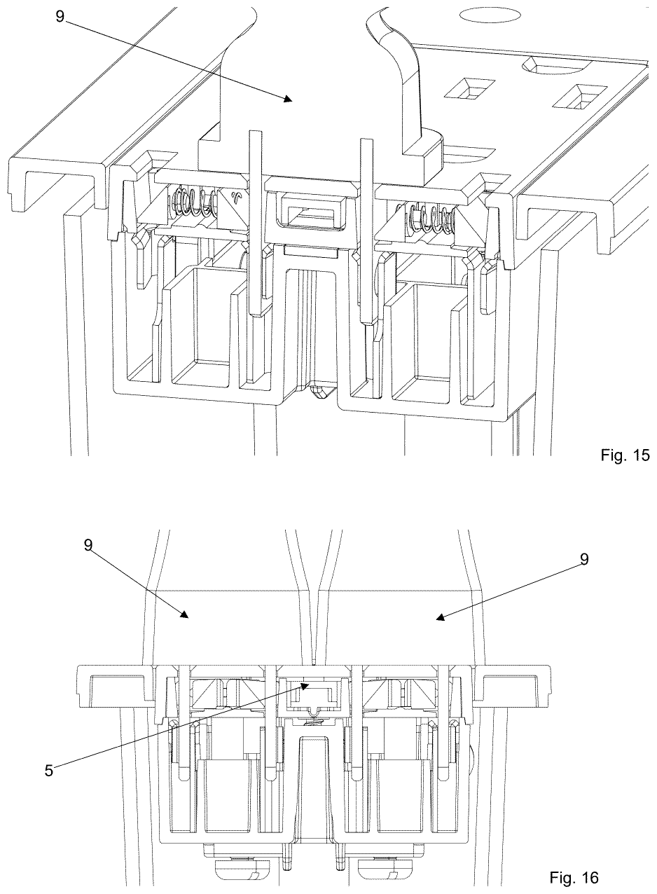

Thereby, the user can connect the plug (without grounding, for example the plugs of class II products with double insulation, razor, computer, hair dryer, flat iron, video recorder, vacuum cleaner, etc.) not only to the first or second outlet 1, 2, but put it straddling the first and second outlet 1, 2 (i.e., one pin of the plug engages in a hole of the first outlet 1 and the other pin of the plug engages in a hole of the second outlet 2; see FIG. 13 or 15). Typically, the inlet mouth of the first hole 13 and the inlet mouth of the second hole 14 are not equal to each other; for example, they are shaped as slots of different height. Suitably, they are rectangular. The inlet mouth of the first hole 13 and the inlet mouth of the third hole 23 are suitably equal to each other. The inlet mouth of the second hole 14 and the inlet mouth of the third hole 23 are different from each other. The inlet mouth of the third hole 23 and the inlet mouth of the fourth hole 24 have different dimensions. The inlet mouth of the second hole 22 and the inlet mouth of the fourth hole 24 are equal to each other.

The port 10 comprises a first mechanical safety shutter 3 protecting the first electrical outlet 1. It is a system known in general terms and which prevents a user who inserts a finger or other conductive element in the first hole from being electrocuted. To release the first shutter 3, two pins must be inserted in the first outlet 1 (in particular in the first and second hole 13, 14). The first shutter 3 comprises a first and a second shield 31, 32. The first and second shield 31, 32 are suitably connected to each other. Advantageously, the first and second shield 31, 32 can be moved towards/away from each other along a first direction 37. Suitably, the first and second shield are movable (in particular they can be moved towards/away, even more in particular they can be moved towards/away along a first direction 37) between a first and a second position. Both the first and second shield 31, 32 have a slide intended to come into contact with pins of an external plug. Suitably, the slide of the first and second shield 31, 32 face an inlet of the first and second hole 13, 14, respectively. Furthermore, imaginary extensions of the slides of the first and the second shield are convergent. The slides are not facing each other, they are facing in different directions. The first shutter 3 comprises first elastic means 34 operatively interposed between the first and second shield 31, 32 (advantageously the first elastic means 34 connects the first and second shield 31, 32). The elastic means 34 comprises for example a spring, typically a helical spring. The elastic means 34 pushes the first and second shield 31, 32 away from each other. In particular, it pushes them in opposite directions. The elastic means 34 pushes the first and second shield 31, 32 from the second towards the first position. Therefore, once the plug is removed, the first and second shield 31, 32 autonomously move from the second to the first position.

In the first position, the first and second shield 31, 32 occlude the first and second hole 13, 14 (respectively) of the first outlet 1. In the second position, the first and second shield 31, 32 free the first and second hole 13, 14 and allow the insertion of an electric plug inside the first and second hole 13, 14. The first shutter 3 is tiltable, in particular about a first axis 30. Suitably, the first axis 30 extends along a direction which is transverse (preferably orthogonal) to the first direction 37. The first axis 30 extends parallel to a plane defined by: the inlet mouth of the first hole 13, the inlet mouth of the second hole 14, the inlet mouth of the third hole 23, the inlet mouth of the fourth hole 24. The first axis 30 extends along a direction which connects the first and second shutter 3, 4. The first shutter 3 is tiltable between a balanced position and unbalanced positions. In the balanced position, the first shutter 3 allows the mutual approach of the first and second shield 31, 32 and the movement from the first to the second position. In the unbalanced positions, the first and second shield 31, 32 are in the first position.

The first shutter 3 further comprises first abutment means 33 which in the unbalanced positions abuts the first and/or second shield 31, 32, preventing the passage from the first to the second position. The first abutment means 33 comprises/is for example a first and/or a second step 331, 332. The upper part of the first and second step 331, 332 is located/ends on a wall 333 on which the first and second shield 31, 32 slide during the passage from the first to the second position and/or vice versa. In the balanced position, the first shutter 3 lies substantially parallel to a plane containing a mouth of the first and second hole 13, 14. With such an orientation, the first and second shield 31, 32 can move towards and away from each other without intercepting the first abutment means 33. In the unbalanced positions, the first shutter 3 is inclined with respect to such an orientation and a movement of the first and/or second shield 31, 32 is prevented by the first abutment means 33 (which is positioned along the trajectory of the first and second shield 31, 32 towards each other).

The port 10 comprises a second mechanical safety shutter 4 protecting the second electrical outlet 2.

The second shutter 4 comprises a third and a fourth shield 41, 42. The third and fourth shield 41, 42 are suitably connected to each other. The third and fourth shield 41, 42 can advantageously be moved towards/away between a first and a second location along a movement direction 47. The directions 37 and 47 are parallel. The first and second shield 31, 32 can be moved towards/away along the same straight line along which the third and fourth shield 41, 42 can be moved towards/away.

In the first location, the third and fourth shield 41, 42 occlude the third and fourth hole 23, 24 (respectively); in the second location, the third and fourth shield 41, 42 free the third and fourth hole 23, 24 and allow the insertion of an electric plug inside the third and fourth hole 23, 24. The second shutter 4 is tiltable about a second axis 40 extending along a direction which is transverse (preferably orthogonal) to the movement direction 47. The first and second axis 30, 40 are parallel and spaced from each other. The second shutter 4 is tiltable between a balanced configuration and unbalanced configurations. In the balanced configuration, it allows the approach of the third and fourth shield 41, 42 and the passage from the first to the second location. In the unbalanced configurations, the third and fourth shield 41, 42 are in the first location.

The second shutter 4 comprises second abutment means 43 which in the unbalanced configurations abuts the third and/or fourth shield 41, 42, preventing the passage from the first to the second location.

One or more of the characteristics described with reference to the first shutter 3 can be repeated for the second shutter 4. Suitably, the first and second shutter 3, 4 are identical or specular.

The port 10 comprises a rocker 5 connecting the first and second shutter 3, 4. The rocker 5 is physically interposed between the first and second shutter 3, 4. The connecting rocker 5 is tiltable about a rotation axis 50. It is thereby possible to maintain the first shutter 3 in the balanced position and the second shutter 4 in the balanced configuration upon the insertion of a pin in the second hole 14 and a pin in the third hole 23, leaving the first and fourth hole 13, 24 free. In fact, such a rocker 5 prevents the first shutter 3 (associated with the first outlet 1) from intervening. In the absence of the rocker 5, if an attempt is made to insert a pin in the second hole 14 of the first outlet (and not also in the first hole 13), the first shutter 3 would intervene. Similarly, the rocker 5 prevents the second shutter 4 (associated with the second outlet 2) from intervening due to the fact that a pin is inserted only in the third hole 23 of the second outlet 2 (and not also in the fourth hole 24).

The rocker 5 comprises a first arm 51, a second arm 52 and a rotation element 54 of the rocker 5 about the rotation axis 50. The rotation axis 50 is parallel and equidistant from the first and second axis 30, 40. The rotation element 54 is interposed between the first and second arm 51, 52. The element 54 can be shaped as a pin 540 intended to rotate in a housing seat (such a housing seat could be obtained in a support facing the pin). If necessary (solution not illustrated), the element 54 could comprise/be a housing seat in which a pin rotates (the pin could be obtained in a support facing the housing seat). The first arm 51 can be shaped as a C-structure. The first arm 51 therefore comprises a common element 510 from which two protrusions 511, 512 project. One or more of the characteristics described with reference to the first arm 51 can be repeated for the second arm 52. In particular, the first and second arm 51, 52 are specular. The first arm 51 is rotatably connected to the first shutter 3, the second arm 52 is rotatably connected to the second shutter 4. In particular, the two protrusions 511, 512 of the first arm 51 are hinged to the first shutter 3.

The first shutter 3 comprises a first longitudinal guide 35 which constrains the movement of the first and second shield 31, 32 along such a first guide 35; in particular, the first guide 35 allows the translation of the first and second shield 31, 32 along the first guide 35. The first guide 35 is rotatably connected to the first arm 51 of the rocker 5 (in particular, as explained above, it is hinged to one of the two protrusions 511, 512 of the first arm 51).

Suitably, the first guide 35 comprises a first side 351 comprising a first projection 352 having longitudinal extension which engages in a first slot 354 obtained on a first wall 353 integral with the first shield 31 and in a second slot 355 obtained on a second wall 356 integral with the second shield 32. The first side 351, the first wall 353 and the second wall 356 are parallel and overlapping. The first guide 35 advantageously also comprises a second side 357 from which a second projection 358 extends having longitudinal extension, which engages in a third slot 359 obtained on a first portion 361 integral with the first shield 31 and in a fourth slot 360 obtained on a second portion 362 integral with the second shield 32. The first guide 35, the first and second wall 353, 356 are parallel and overlapping. Similarly, the first guide 45, the first portion 361 and the second portion 362 are parallel and overlapping.

The second shutter 4 comprises a second longitudinal guide 45 which constrains the movement of the third and fourth shield 41, 42 along such a second guide 45. The second guide 45 is rotatably connected to the second arm 52 of the rocker 5.

The first shutter 3 comprises a first base 36 which interacts with the first guide 35, allowing the first shutter 3 to be tiltable about the first axis 30. The first guide 35 is interposed between the first base 36 and the first hole 13.

The second shutter 4 comprises a second base 46 which interacts with the second guide 45, allowing the second shutter 4 to be tiltable about the second axis 40.

Advantageously, the port 10 comprises a monolithic aesthetic covering 6 in which the inlets are obtained for the first, second, third, and fourth hole 13, 14, 23, 24. Suitably, such a covering is made of plastic, but could also be of different material.

The subject matter of the present invention is an operating method of a power supply port 10 having one or more of the characteristics described above. With reference for example to FIGS. 13 and 15, the method comprises a step of inserting a first and a second pin of the same electric plug in the second and third hole 14, 23, respectively (the second hole 14 is part of the first outlet 1 while the third hole 23 is part of the second outlet 2). Such an electric plug has only two pins (suitably, grounding is absent; typically, plugs of this type relate to small household appliances). Such a step of inserting the first and second pin of an electric plug comprises the step of exerting a pressure on the second and third shield 32, 41 by means of the first and second pin. The step of exerting pressure on the second and third shield 32, 41 exerts a first and a second opposite moment with respect to the rotation axis 50. Thereby, the rocker 5 remains substantially balanced with respect to the rotation axis 50. In particular, the rocker 5 remains parallel to a plane identified by inlet mouths of the first, second, third, fourth hole 13, 14, 23, 24. The first moment is induced by the pressure on the second shield 32. The second moment is induced by the pressure on the third shield 41. The above balance prevents the rocker 5 from being unbalanced in one direction or the other around the rotation axis 50 and thus prevents the first shutter 3 (in particular the second shield 32) from being abutted by the first abutment means 33 or the second shutter 4 (in particular the third shield 41) from being abutted by the second abutment means 43 (alternatively, if only one pin is inserted in the second hole 14, the second shield 32 would be blocked and, in particular, could not move away from the third shield 41 because it is abutted by the step of the first abutment means 33; similarly, if only one pin is inserted in the third hole 23, the third shield 41 would be blocked and, in particular, could not move away from the second shield 32 because it is abutted by the step of the second abutment means 43—see FIG. 14). Consequently, the movement of the second and third shield 32, 41 and the electric power supply of the plug are caused. Without the rocker 5, the first shutter 3 would prevent the entry of a single pin in the first outlet 1; similarly, the second shutter 4 would prevent the entry of a single pin in the second outlet 2. The rocker 5 instead allows the insertion of a plug straddling the first and second outlet 1, 2, preventing the intervention of the first and second shutter 3, 4.

Removing the plug from the second and third hole 14, 23 the second shield and third shield 32, 41 again occlude the second and third hole 14, 23, respectively. In particular, an elastic means pushes the second and third shield 32, 41 towards each other to occlude the second and third hole 14, 23.

The present invention achieves important advantages.

First of all, it allows maximum flexibility. In fact, the user can connect the electric plug to any of the available outlets or even straddling multiple outlets. Therefore, this facilitates the insertion of the plug, for example, in the dark when the user proceeds blindly. Furthermore, it allows connecting the plug where it best suits the user, avoiding any obstacles blocking one or more outlets.

The invention thus conceived is susceptible of numerous modifications and variants, all falling within the scope of the inventive concept that characterises it. Moreover, all the details may be replaced by other technically equivalent elements. All the materials used, as well the dimensions, may in practice be any whatsoever according to needs.

1. An electric power supply port comprising:
i) a first electrical outlet (1) comprising:
first electrical contacts in turn comprising a first phase (11) and a first neutral (12);
a first group of holes in turn comprising at least a first and a second hole (13, 14), one associated with the first phase (11) and one associated with the first neutral (12) and intended to allow an insertion of corresponding pins of an external electric plug;
ii) a second electrical outlet (2) side by side with the first electrical outlet (1);
the second electrical outlet (2) comprising:
second electrical contacts in turn comprising a second phase (21) and a second neutral (22);
a second group of holes in turn comprising at least a third and a fourth hole (23, 24), one associated with the second phase (21) and one associated with the second neutral (22) and intended to allow an insertion of the corresponding pins of the external electric plug; the first, second, third and fourth hole (13, 14, 23, 24) are aligned according to this order along the same straight line; a distance between a geometric centre of gravity of an inlet mouth of the first hole (13) and a geometric centre of gravity of an inlet mouth of the second hole (14) is the same as a distance between the geometric centre of gravity of the inlet mouth of the second hole (14) and a geometric centre of gravity of an inlet mouth of the third hole (23) and is the same as a distance between the geometric centre of gravity of the inlet mouth of the third hole (23) and a geometric centre of gravity of an inlet mouth of the fourth hole (24); between one of the holes of the first group associated with the first phase (11) and one of the holes of the second group associated with the second phase (21), there being one of the holes of the first group associated with the first neutral (12) or one of the holes of the second group associated with the second neutral (22).

2. The port according to claim 1, characterised in that it comprises:
i) a first mechanical safety shutter (3) protecting the first electrical outlet (1), said first shutter (3) comprising:
a first and a second shield (31, 32) which can be moved towards/away along a first direction (37) between a first and a second position; in the first position, the first and second shield (31, 32) occluding the first and second hole (13, 14) of the first outlet (1); in the second position, the first and second shield (31, 32) freeing the first and second hole (13, 14) and allowing the insertion of the electric plug inside the first and second hole (13, 14); said first shutter (3) being tiltable about a first axis (30) extending along a direction which is transverse to the first direction (37); said first shutter (3) being tiltable between a balanced position in which it allows the mutual approach of the first and second shield (31, 32) and the movement from the first to the second position and unbalanced positions in which the first and second shield (31, 32) are in the first position;
first abutment means (33) which in the unbalanced positions abuts the first and/or second shield (31, 32), preventing the passage from the first to the second position;
ii) a second mechanical safety shutter (4) protecting the second electrical outlet (2), said second shutter (4) comprising:
a third and a fourth shield (41, 42) which can be moved towards/away between a first and a second location along a movement direction (47);
in the first location, the third and fourth shield (41, 42) occluding the third and fourth hole (23, 24); in the second location, the third and fourth shield (41, 42) freeing the third and fourth hole (23, 24) and allowing the insertion of the electric plug inside the third and fourth hole (23, 24); said second shutter (4) being tiltable about a second axis (40) extending along a direction which is transverse to the movement direction (47); said second shutter (4) being tiltable between a balanced position in which it allows the approach of the third and fourth shield (41, 42) and the passage from the first to the second location and unbalanced configurations in which the third and fourth shield (41, 42) are in the first location;
second abutment means (43) which in the unbalanced configurations abuts the third and/or fourth shield (41, 42), preventing the passage from the first to the second location;
iii) a rocker (5) connecting the first and second shutter (3, 4); said connecting rocker (5) being tiltable about a rotation axis (50) to maintain the first shutter (3) in the balanced position and the second shutter (4) in the balanced configuration upon the insertion of a pin in the second hole (14) and a pin in the third hole (23), leaving the first and fourth hole (13, 24) free.

3. The port according to claim 2, characterised in that said rocker (5) comprises a first arm (51) and a second arm (52) and a rotation element (54) of the rocker (5) about the rotation axis (50); said rotation element (54) being interposed between the first and second arm (51, 52); the first arm (51) being rotatably connected to the first shutter (3), the second arm (52) being rotatably connected to the second shutter (4).

4. The port according to claim 2, characterised in that both the first and second shield (31, 32) have a slide intended to come into contact with pins of the electric plug;
the first shutter (3) comprising first elastic means (34) operatively interposed between the first and second shield (31, 32).

5. The port according to claim 1, characterised in that the first hole (13) and the third hole (23) are equal to each other and the second hole (14) and the third hole (23) are equal to each other; the first and second hole (13, 14) have different dimensions to each other.

6. The port according to claim 3, characterised in that the first shutter (3) comprises a first longitudinal guide (35) which constrains the movement of the first and second shutter (3, 4) along such a first guide (35); said first guide (35) being rotatably connected to the first arm (51) of the rocker (5); the second shutter (4) comprises a second longitudinal guide (45) which constrains the movement of the first and second shutter (3, 4) along such a second guide (45); said second guide (45) being rotatably connected to the second arm (52) of the rocker (5).

7. The port according to claim 6, characterised in that the first shutter (3) comprises a first base (36) which interacts with the first guide (35), allowing the first shutter (3) to be tiltable about the first axis (30);
the second shutter (4) comprises a second base (46) which interacts with the second guide (45), allowing the second shutter (4) to be tiltable about the second axis (40).

8. The port according to claim 1, characterised in that it comprises a monolithic aesthetic covering (6) in which the inlets are obtained for the first, second, third, and fourth hole (13, 14, 23, 24).

9. An operating method of a power supply port according to claim 2, comprises the step of inserting a first and a second pin of an electric plug in the second and third hole (14, 23), respectively; the step of inserting the first and second pin of the electric plug comprising the step of exerting a pressure on the second and third shield (32, 41) by means of the first and second pin; the step of exerting said pressure on the second and third shield (32, 41) by exerting a first and a second opposite moment with respect to the rotation axis (50) and maintaining the rocker (5) substantially balanced with respect to the rotation axis (50); said first moment being induced by the pressure on the second shield (32), said second moment being induced by the pressure on the third shield (41); said balance preventing the rocker (5) from unbalancing in one direction or the other around the rotation axis (50) and thus preventing the first shutter (3) from being abutted by the first abutment means (33) or the second shutter (4) from being abutted by the second abutment means (43) and consequently allowing the movement of the second and third shield (32, 41) and the electric power supply of the plug.
